(19) United States
(12) Patent Application Publication
(10) Pub. No.: US 2004/0142598 A1
(43) Pub. Date: Jul. 22, 2004

(54) Plug-in connector

(76) Inventor: Jurgen Lappohn, Gammelshausen (DE)

Correspondence Address: WILLIAM COLLARD, COLLARD & ROE, P.C., 1077 NORTHERN BOULEVARD, ROSLYN, NY, 11576, US

(21) Appl. No.: 10/682,212

(22) Filed: Oct. 8, 2003

(30) Foreign Application Priority Data
Oct. 10, 2002 (DE) 102 47 274.2

(51) Int. Cl. H01R 13/648

(52) U.S. Cl. 439/607

(57) ABSTRACT

A plug-in connector for electronic components having contacts that are shielded towards the outside by a shielding that comprises one or more shielding plates. The outer shielding plate is bent at a bending site so that it rests on the corpus on at least two sides. To fix the bent segment of the shielding plate in place on the corpus, the corpus is provided with recesses that interact with catch hooks on the corpus, in the manner of a catch connection. The bending site is provided with a weakening in the thickness of the shielding plate.

### BACKGROUND OF THE INVENTION

1. Field of the Invention

The present invention relates to a plug-in connector to connect electrical components. Such plug-in connectors are, among other things, blade or spring strips, multi-pole plugs or plug elements or the like, as they are known to a person skilled in the art.

2. The Prior Art

The known plug-in connectors have a corpus that is essentially configured in a block shape. Electrical contacts are arranged in the interior of the corpus, for example inserted in a releasable or lockable manner, which transmit electrical signals or pulses. These electrical contacts can also be angled at 90°.

Shielding plates that are arranged on the outside of the corpus of the plug-in connector and form single-part or multi-part shields shield the electrical contacts arranged in the plug-in connector. The shielding plates are essentially formed by metal sheets that are sized according to the shape of the corpus, and that essentially surround the corpus completely.

To simplify the production of such plug-in connectors, the shielding plates are configured so that the entire area of one of their surfaces rests against one side of the corpus. Additional surfaces, i.e., the side surfaces, are formed onto this base surface, in one piece, and are angled off in accordance with the body shape of the corpus of the plug-in connector in question, which is to be shielded, even before its assembly. Such a plug-in connector is shown in U.S. Pat. No. 6,319,063 B1.

Angling or bending of partial regions of the shielding plate takes place first, before it is connected with the corpus. Such plug-in connectors having a shielding part consisting of two half shells are known from German Patent No. DE 42 07 461 C1 or from U.S. Pat. No. 5,236,375. With these plug-in connectors, the shielding part is also sheathed by a housing part, a cap, or a similar component.

It is disadvantageous, because of the elastic restoring forces at the bending site of the shielding plate, that the shielding plate either does not rest against the second side over its full area, by itself, or that a prior excess bend, i.e. a bend of more than 90°, of the shielding plate is necessary, in order for the shielding plate to rest closely against the corpus on the second or additional side. These disadvantages have the result, particularly in the case of partially automatic or fully automatic assembly of a plug-in connector, of an increased assembly time or additional assembly aids.

### SUMMARY OF THE INVENTION

It is therefore an object of the invention to improve a plug-in connector with shielding, in such a manner that at least one shielding plate rests directly against the corpus of the plug-in connector with its sides/surfaces, and that this arrangement is permanently assured, and that prerequisites for an improved assembly of the plug-in connector are created.

According to the invention, this task is accomplished by means of a plug-in connector comprising a plurality of electrical contacts arranged in an essentially block-shaped corpus, and an electrical shielding of the contacts, the shielding having at least one shielding plate arranged on the corpus and surrounding the corpus on two sides. The shielding plate has a weakening in its thickness in a region of a bending site of the shielding plate, which divides the shielding plate into a first segment and a second segment.

The bending site of the outer shielding plate of the shielding, which is, as a rule, the segment of the shielding plate that faces away from the plug-in side of the plug-in connector, i.e. the site at which bending takes place between the first and the second segment of this shielding plate, is weakened. This means that here, the shielding plate is constructed with a lesser thickness. This either takes place during the production of the shielding plate, or can be done subsequently, by means of material removal at the subsequent bending site.

Because of the weakening in the material thickness at the bending site, the forces required to bend the second segment relative to the first are reduced and elastic restoring forces at the bending site are reduced by this weakness. As a result, essential prerequisites for a more effective assembly are created, particularly for an automated assembly of the plug-in connector.

Preferably, the weakening is arranged or formed on the inside of the bending site. In this way, bending of the two segments relative to one another is facilitated, since no material has to be displaced here.

In a second embodiment of the new plug-in connector, the segment of the shielding plate that is essentially bent by 90° during the production of the complete plug-in connector is provided with recesses. Furthermore, catch hooks are formed on the side of the corpus that is covered by the segment of the shielding plate mentioned above, in the final state. The catch hooks and the recesses can then interact in the manner of a catch connection.

The invention has the advantage that when the aforementioned segment of the shielding plate is bent, the catch hooks engage in the recesses and thereby hold this segment of the shielding plate in place, resting against this side of the corpus, so that it is prevented from springing back as a result of the restoring forces in the region of the bending site of the metal shielding plate. Furthermore, because of the catch connection, the shielding plates are permanently aligned in their position that shields the plug-in connector.

In advantageous manner, the corpus of the plug-in connector consists of plastic, in order to produce it in an injection-molding process. In this connection, the catch hooks can be formed in one piece with the corpus during its production process.

In order to align the recesses of the shielding plate with the catch hooks on the corpus, several positioning projections, preferably also in one piece with the corpus, are provided on the corpus. The projections interact with corresponding positioning recesses in the shielding plate. These positioning aids guarantee, during bending of the segment of the shielding plate, that slight deviations in a bending procedure are evened out, in order to ensure the catch connection. In other words, the segment to be bent is aligned into the desired position during bending, using these positioning aids.

Known catch devices that are formed on the first segment of the shielding plate secure a first segment of the shielding plate, i.e., the entire shielding plate in place. These catch devices consist of catch hooks formed onto the shielding plate, in one piece with it, which can be brought into engagement in corresponding recesses, undercuts, or pockets in the region of the face of the corpus of the plug-in connector.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a plug-in connector having a shielding configured according to the invention, in a schematic side view, in cross-section, and

FIG. 2 shows another embodiment of the new plug-in connector according to FIG. 1.

### DETAILED DESCRIPTION OF THE PREFERRED EMBODIMENT

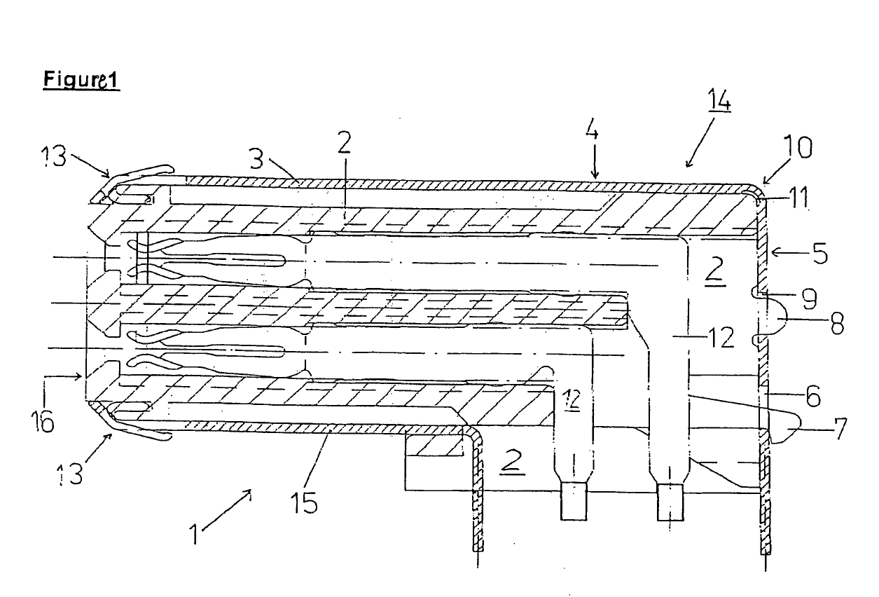

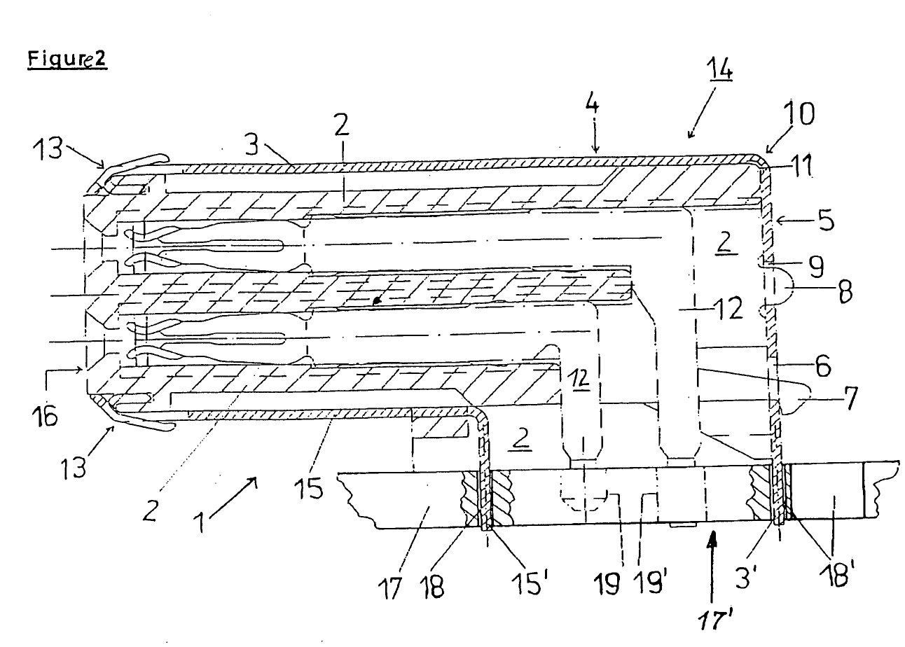

Referring now in detail to the drawings FIGS. 1 and 2 show a plug-in connector 1 having a dielectric corpus 2, preferably made of plastic. Several electrical contacts 12 are arranged in the corpus 2. Here, contacts 12 are bent at an angle and are configured as a spring at one of their ends. In FIG. 1, the parts of the outer sheath of the plug-in connector are not shown.

Shielding plates 3 and 15 electrically shield contacts 12, which plates surround corpus 2 of plug-in connector 1 essentially on all sides and continuously. In other words, the shielding is in two parts here. Shielding plate 15 is configured in a conventional manner and shields the inside of plug-in connector 1 as well as the side surfaces of plug-in connector 1, which cannot be seen in this cross-sectional view.

However, shielding plate 3 has a new structure. Outer shielding plate 3 has two segments 4, 5, which are connected with one another at a bending site 10. In the production of plug-in connector 1, after corpus 2, together with contacts 12 that are contained in it has been positioned in the first part of shielding 14, shielding plate 3 is fixed in place on the corpus 2 with its first segment 4 resting against one side of the corpus 2, by way of a catch connection 13. Here, this catch connection 13 is preferably arranged facing towards the face, in other words on the so-called plug end 16, in the edge region. Subsequently, the second segment 5 is bent at the bending site 10, and this angled segment 5 of the shielding plate 3 is connected with the corpus 2. Catch hooks 7, which are integrally formed on the corpus 2, fix segment 5 in place on corpus 2, engage in recesses 6 in the second segment 5, and thereby fix segment 5 in place on the side of corpus 2.

Catch connection 13 described above can be formed in a known manner, using catch hooks on the shielding plate 3 and recesses, pockets or the like on corpus 2.

One or more additional positioning projections 8 align second segment 5 relative to catch hooks 7, which projections are preferably also formed onto corpus 2, in one piece with it. These projections engage in positioning recesses 9 in second segment 5 of shielding plate 3. In this way, it is guaranteed that recess 6 is arranged in the correct position relative to catch hook 7, during the bending process.

Furthermore, outer shielding plate 3 has a weakening 11 in the material thickness of shielding plate 3 at bending site 10. This weakening 11 can be produced either by material removal at shielding plate 3, or can already be provided during the production of shielding plate 3.

Weakening 11 facilitates bending at bending site 10, since the material of shielding plate 3, which is thinner here, presents less resistance to the bending process, and also, the elastic restoring forces that occur are not as great.

All of the characteristics mentioned in the above description as well as those that are only evident from the drawings are further integral parts of the invention, even if they have not been particularly emphasized and mentioned in the claims. The invention is not restricted to the exemplary embodiment, but rather can be varied in many different ways, within the scope of the disclosure.

For example, shielding 14, which is configured in a new way, can, at the same time, be an outer housing part of a plug-in connector 1, since the components of shielding 14, without springing back after having been bent on the corpus, remain positioned closely, in other words without a gap, against the respective surfaces of corpus 2 that contains contacts 12 (see FIG. 1 and FIG. 2). Because of the aforementioned new type of configuration and positioning of shielding 14, the plug-in connector 1 can be inserted into a circuit board 17 equipped with a predetermined pattern of contact holes 19, 19′, 18, and 18′, immediately after outer shielding plate 3 has been bent, as shown in FIG. 2.

However, it also lies within the scope of the invention if the partially assembled plug-in connector 1 is positioned on the circuit board 17 after (inner) shielding plate 15 rests against corpus 2 equipped with contacts 12. In this connection, a free end 15′ of shielding plate 15 engages in a contact hole 18, and the circuit-board-side end of contacts 12 engages a contact hole 19′, in each instance, or the circuit-board-side end of a contact 12 penetrates into a contact bushing 19. Only after corpus 2 rests against circuit board 17 is the outer shielding plate 3 then laid against corpus 2 and bent towards the circuit board 17. In the end phase of the bending process, the free end 3′ of second segment 5 passes through contact slit 18′ in circuit board 17. After second segment 5 locks in place on catch hook 7, the final position of shielding plate 3 as shown in FIG. 2 is the result. The free ends 3′ and 15′ of shielding 14 project slightly beyond the opposite side 17′ of circuit board 17, and are locked in place on circuit board 17 by means of soldering, bending in the direction of circuit board 17, or by being rotated about their longitudinal body axis.

The new shielding shown in FIG. 2 is an improved strain relief for the connection of contacts 12 with electrically conductive leads/conductor tracks, which are not shown in FIG. 2, i.e. with contact elements 19 and 19′ of circuit board 17.

The new shielding can also consist of a single shielding plate, which has a corresponding number of surfaces, and bending sites weakened according to the invention, as well as the catch connections.

Accordingly, while only a few embodiments of the present invention have been shown and described, it is obvious that many changes and modifications may be made thereunto without departing from the spirit and scope of the invention.

List of Reference Numerals

1 plug-in connector

2 corpus of Item 1

3 shielding plate on Item 2 (outer shielding plate)

3′ free end of Item 5

4 first segment of Item 3

5 second segment of Item 3

6 recess in Item 5

7 catch hook on Item 2

8 positioning projection on Item 2

9 positioning recess on Item 5

10 bending site on Item 3

11 weakening on Item 3

12 electrical contacts in Item 2

13 catch device on the face

14 shielding of Item 1

15 inner shielding plate

15′ free end of item 15

16 face of Item 1 (plug end)

17 circuit board

17′ opposite side of Item 17

18 contact hole

18′ contact slit

19 contact bushing

19′ contact hole

What is claimed is:

1. A plug-in connector to connect electronic components, comprising:
a plurality of electrical contacts arranged in an essentially block-shaped corpus;
an electrical shielding of the contacts, said shielding having at least one shielding plate arranged on the corpus and surrounding the corpus on two sides, said shielding plate having a weakening in its thickness in a region of a bending site of the shielding plate, said bending site dividing said shielding plate into a first segment and a second segment.

2. The plug-in connector according to claim 1, wherein the weakening is arranged on an inside of the bending site.

3. The plug-in connector according to claim 1, further comprising:
at least one recess in the shielding plate, said at least one recess being disposed on the second segment of said shielding plate; and
at least one catch hook formed on a corresponding side of the corpus,
wherein the at least one catch hook and the at least one recess interact as a catch connection.

4. The plug-in connector according to claim 3, wherein the at least one catch hook is integrally formed on the corpus.

5. The plug-in connector according to claim 3, further comprising additional catch devices formed on the first segment of the shielding plate or on a corresponding segment of the corpus.

6. The plug-in connector according to claim 1, further comprising positioning projections on the corpus, said positioning projections interacting with corresponding positioning recesses on the shielding plate.

7. The plug-in connector according to claim 1, wherein the corpus is made of plastic.

8. A method for positioning a shielding plate of a shielding of a plug-in connector on the plug-in connector, said connector containing electrical contacts that are arranged in an essentially block-shaped corpus, wherein a shielding plate of the shielding is arranged to surround the corpus on at least two sides of the corpus, the shielding plate comprising a first segment and a second segment and a bending site in a transition region between the two segments, said bending site being created by a weakening in a thickness of the shielding plate, said method comprising the steps of:
positioning the shielding plate against a side of the corpus with its first segment during the production of the shielding of the plug-in connector;
fixing said shielding in place on the corpus by way of a catch connection;
bending the second segment at the bending site; and
locking the second segment in place, via at least one catch hook on the corpus, said catch hook passing through a recess in the second segment.

9. The plug-in connector according to claim 1, wherein the connector is positioned on a circuit board and wherein the at least one shielding plate forms an outer housing part of the plug-in connector, said plate having a free end that passes through the circuit board and is anchored in place on an opposite side of said circuit board.

10. The method according to claim 8, further comprising positioning the connector on a circuit board such that a free end of the plate passes through the circuit board and is anchored in place on an opposite side of said circuit board.
